(19) United States
(12) Patent Application Publication
(10) Pub. No.: US 2012/0297078 A1
(43) Pub. Date: Nov. 22, 2012

(54) METHOD AND DEVICE FOR PERFORMING SERVICE IN NETWORK

(75) Inventors: Jung-kih Hong, Seoul (KR); Yeo-jun Yoon, Suwon-si (KR); Min-suk Choi, Gumi-si (KR); Seong-hoon Kang, Suwon-si (KR)

(73) Assignee: Samsung Electronics Co., Ltd., Suwon-si (KR)

(21) Appl. No.: 13/363,891

(22) Filed: Feb. 1, 2012

(30) Foreign Application Priority Data
May 20, 2011 (KR) 10-2011-0047949

(51) Int. Cl. G06F 15/16

(52) U.S. Cl. 709/228

(57) ABSTRACT

Methods and devices are provided for performing a service between devices in a network. A predetermined event for starting the service is recognized in a first device. A pairing is performed between the first device and a second device that is a party of the service. The pairing is ended by setting information for performing the service. The service between the first device and the second device is performed. The pairing is ended before or during performance of the service.

### PRIORITY

This application claims priority under 35 U.S.C. 119(a) to Korean Patent Application No. 10-2011-0047949, filed on May 20, 2011, in the Korean Intellectual Property Office, the disclosure of which is incorporated herein by reference.

### BACKGROUND OF THE INVENTION

1. Field of the Invention

The present invention relates generally to network services, and more particularly, to a method of performing a service between devices in a network regardless of whether a service between a service providing device and a service receiving device ends.

2. Description of the Related Art

When services are performed between devices in a network, a host device must first be selected. A user of the host device then inputs a scan command to search for other neighboring devices. Devices that will operate as guests are directly selected from among the devices found in the search.

Devices are unable to freely share content as soon as they form a network.

FIG. 1 is a diagram illustrating a network formed with a plurality of devices. The plurality of devices in the network are grouped into a plurality of network groups; namely network group A, network group B, and network group C. A host device is selected from each of network groups A, B, and C. A user searches for other devices in corresponding network groups by inputting a scan command into each host device. The user then selects devices that will operate as guests.

FIG. 2 is a flowchart illustrating a method of performing a service between devices in a network. In step 201S, a user searches for other devices in a corresponding network group by inputting a scan command into a host device. In step 203S, the user selects devices that will operate guests from among the devices found in the search. In step 205S, pairing is performed between the host device (a service providing device) and a guest device (a service receiving device). In step 207S, a service is performed between the host device and the guest device.

FIG. 3 is a flowchart illustrating another method of performing a service between devices in a network. In step 301S, a network group in which a service is to be performed is set (or selected). For example, one of network groups A, B, and C, shown in FIG. 1, is selected. In step 303S, a state of a link command of a user device is set to “ON”. In step 305S, it is determined whether any other device belonging to the set network group and having a link command state of “ON” exists around the user device. If no other device exists around the user device, the user device participates in the network group as a host device, in step 307S. In step 309S, it is again determined whether any other device belonging to the set network group and having a link command state of “ON” exists around the user device. If no other device exists around the user device, the user device repeats step 309S and continues to search. If another device exists around the user device, the found device participates in the network group as a guest, in step 311S. In step 313S, the service is performed. If it is determined in step 305S that another device exists around the user device, the user device participates in the network group as a guest, in step 315S, and the service is performed in step 313S.

Thus, in accordance with FIGS. 1-3, network group setup is separately required, and a host/guest mode needs to be checked while performing a service. Also, waiting for an additional service is required in performing a service. Further, authentication for performing the service is required. The authentication for performing the service requires an acceptance for receiving content in the guest mode. A physical input device for performing an authentication operation is necessary.

### SUMMARY OF THE INVENTION

The present invention has been made to address at least the above problems and/or disadvantages and to provide at least the advantages described below. Accordingly, an aspect of the present invention provides methods and apparatus for performing a service between devices in a network.

According to an aspect of the present invention, a method is provided for performing a service between devices in a network. A predetermined event for starting the service is recognized in a first device. A pairing is performed between the first device and a second device that is a party of the service. The pairing is ended by setting information for performing the service. The service between the first device and the second device is performed. The pairing is ended before or during performance of the service.

According to another aspect of the present invention, a method is provided for performing a service between devices in a network. A predetermined event for starting the service is recognized in a first device. A host device and a guest device are determined from the first device and a second device that is a party of the service. A pairing is performed between the first device and the second device based on the determination of the host device and the guest device. The pairing is ended by setting information for performing the service. The service is performed between the first device and the second device. The pairing is ended before or during performance of the service.

According to an additional aspect of the present invention, a method is provided for performing a service between devices in a network. The network is formed with a plurality of devices. A predetermined event for starting the service with a second device of the plurality of devices is recognized in a first device of the plurality of devices. Another device, from among the plurality of devices, is searched for that has recognized the predetermined event and has the second device as another party of the service. When another device is not found, pairing is performed between the first device and the second device. When another device is found, a service performing order between the first device and the found device is determined, and the pairing between the first device and the second device is performed when it is time to provide the service by the first device in accordance with the service performing order. The pairing is ended by setting information for performing the service. The service is performed between the first device and the second device. The pairing is ended before or during performance of the service.

According to a further aspect of the present invention, a device is provided for performing a service in a network. The device includes an event recognizer for recognizing a predetermined event for starting the service, and a pairing information generator for generating information regarding pairing performed between the device and another device of the service. The device also includes a pairing information transceiver for transmitting and receiving the pairing information between the device and the other device of the service, and a service performing unit for performing the service. The device further includes a service transceiver for transmitting and receiving the performed service between the device and the other device of the service, and a controller for controlling the event recognizer, the pairing information generator, the pairing information transceiver, the service performing unit, and the service transceiver. The transmission and reception of the pairing information end before or during performance of the service.

According to another aspect of the present invention, a device is provided for performing a service in a network. The device includes an event recognizer for recognizing a predetermined event for starting the service, and a host/guest determiner for determining a host device and a guest device from the device and an other device of the service. The device also includes a pairing information generator for generating information regarding pairing performed between the device and the other device of the service based on the determination of the host device and the guest device, and a pairing information transceiver for transmitting and receiving the pairing information between the device and the other device of the service. The device further includes a service performing unit for performing the service, a service transceiver for transmitting and receiving the performed service between the device and the other device of the service, and a controller for controlling the event recognizer, the host/guest determiner, the pairing information generator, the pairing information transceiver, the service performing unit, and the service transceiver. The transmission and reception of the pairing information end before or during performance of the service.

Additionally, according to a further aspect of the present invention, a device is provided for performing a service in a network. The device includes an event recognizer for recognizing a predetermined event for starting the service with a second device, and a device search unit for searching for another device that has recognized the predetermined event and has the second device as another party of the service. The device also includes a service performing order determiner for, when another device is found, determining a service performing order between the device and the found device, and a pairing information generator for generating information regarding pairing performed between the device and the second device. The device further includes a pairing information transceiver for transmitting and receiving the pairing information between the device and the second device, when it is time to provide the service by the first device in accordance with the determined service performing order. Additionally, the device includes a service performing unit for performing the service, and a service transceiver for transmitting and receiving the performed service between the device and the second device. The device also includes a controller for controlling the event recognizer, the device search unit, the service performing order determiner, the pairing information generator, the pairing information transceiver, the service performing unit, and the service transceiver. The transmission and reception of the pairing information end before or during performance of the service.

### BRIEF DESCRIPTION OF THE DRAWINGS

The above and other aspects, features and advantages of the present invention will become more apparent from the following detail description when taken in conjunction with the accompanying drawings, in which:

FIG. 1 is a diagram illustrating a network formed with a plurality of devices;

FIG. 2 is a flowchart illustrating a method of performing a service between devices in a network;

FIG. 3 is a flowchart illustrating another method of performing a service between devices in a network;

FIG. 4 is a diagram illustrating a plurality of devices participating in a network, according to an embodiment of the present invention;

FIG. 5 is a flowchart illustrating a method of performing a service between devices in a network, according to an embodiment of the present invention;

FIG. 6 is a flowchart illustrating a method of performing a service between devices in a network, according to another embodiment of the present invention;

FIG. 7 is a flowchart illustrating a method of performing a service between devices in a network, according to another embodiment of the present invention;

FIGS. 8A and 8B illustrate display screens of two devices of a plurality of devices participating in a network, according to an embodiment of the present invention;

FIGS. 9A and 9B are diagrams illustrating an operation between a service providing device and a service receiving device when pairing has already been set between the two devices of a plurality of devices participating in a network, according to an embodiment of the present invention;

FIG. 10 is a block diagram illustrating a device for performing a service in a network, according to an embodiment of the present invention;

FIG. 11 is a block diagram illustrating a device for performing a service in a network, according to another embodiment of the present invention; and

FIG. 12 is a block diagram illustrating a device for performing a service in a network, according to another embodiment of the present invention.

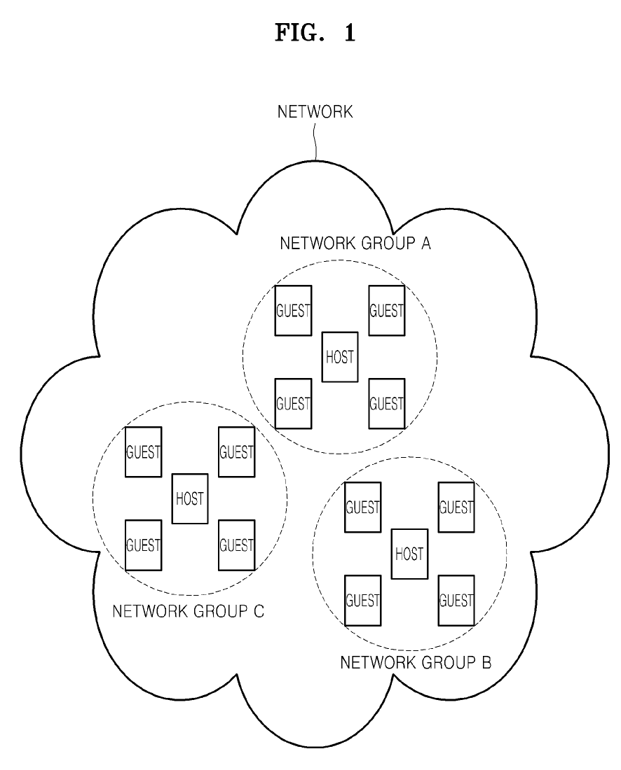

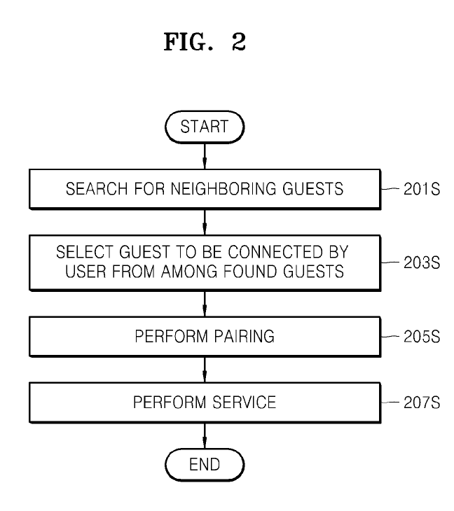

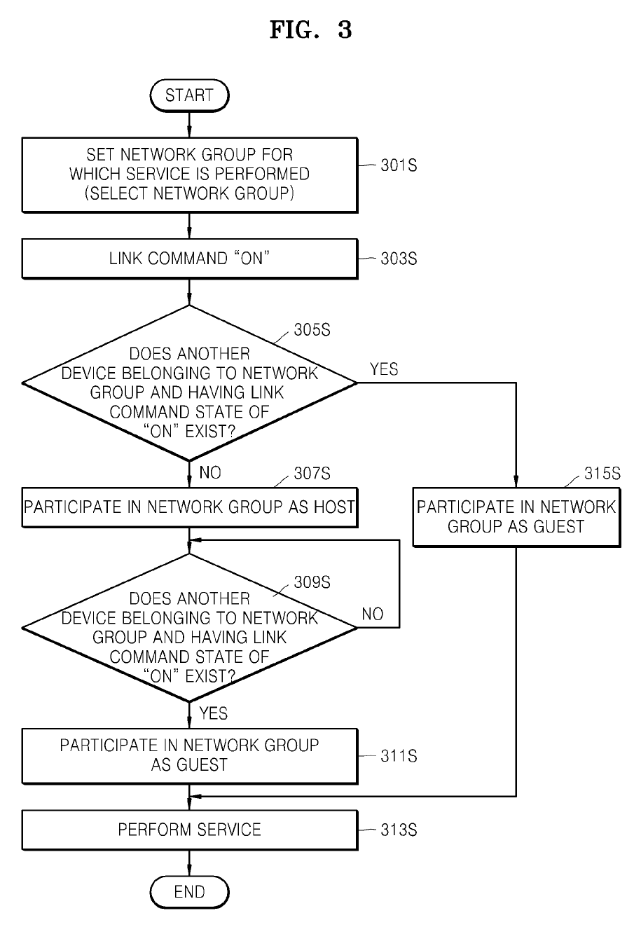

### DETAILED DESCRIPTION OF EMBODIMENTS OF THE PRESENT INVENTION

Embodiments of the present invention are described in detail with reference to the accompanying drawings. The same or similar components may be designated by the same or similar reference numerals although they are illustrated in different drawings. Detailed descriptions of constructions or processes known in the art may be omitted to avoid obscuring the subject matter of the present invention.

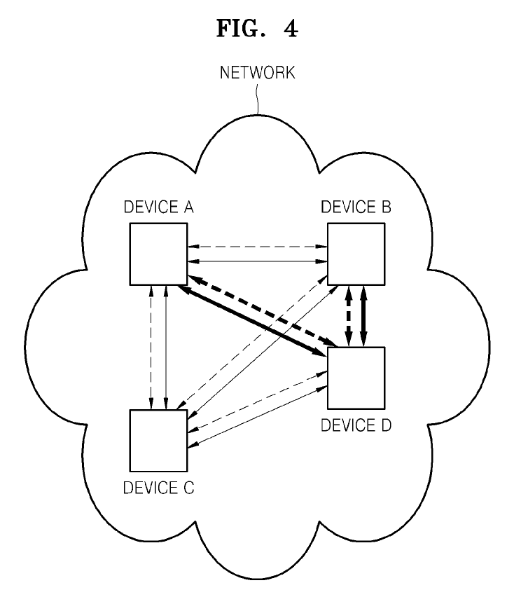

FIG. 4 is a diagram illustrating a plurality of devices participating in a network, according to an embodiment of the present invention.

Devices A, B, C, and D, participating in the network, perform pairing and a service, independent of each other. For example, pairing/service between devices A and B is performed independent of pairing/service between the devices A and D. In FIG. 4, performing of pairing is indicated with dashed arrows, and performing of a service is indicated with solid arrows. Because pairing/service is independently performed between devices participating in the network, device A can perform pairing/service with devices C and D, while device A is performing a service with device B.

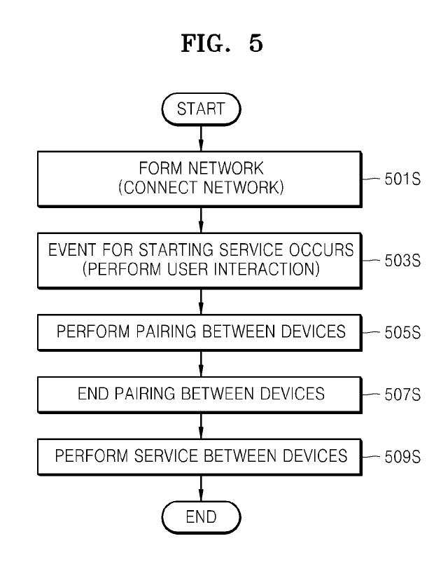

FIG. 5 is a flowchart illustrating a method of performing a service between devices in a network, according to an embodiment of the present invention. Specifically, with respect to the embodiment of the present invention illustrated in FIG. 5, pairing/service can be performed between two arbitrary devices in the network regardless of whether the service ends between the devices in the network.

Referring to FIG. 5, in step 501S, a network is formed with a plurality of devices. For example, devices A, B, C, and D form a single network, as shown in FIG. 4.

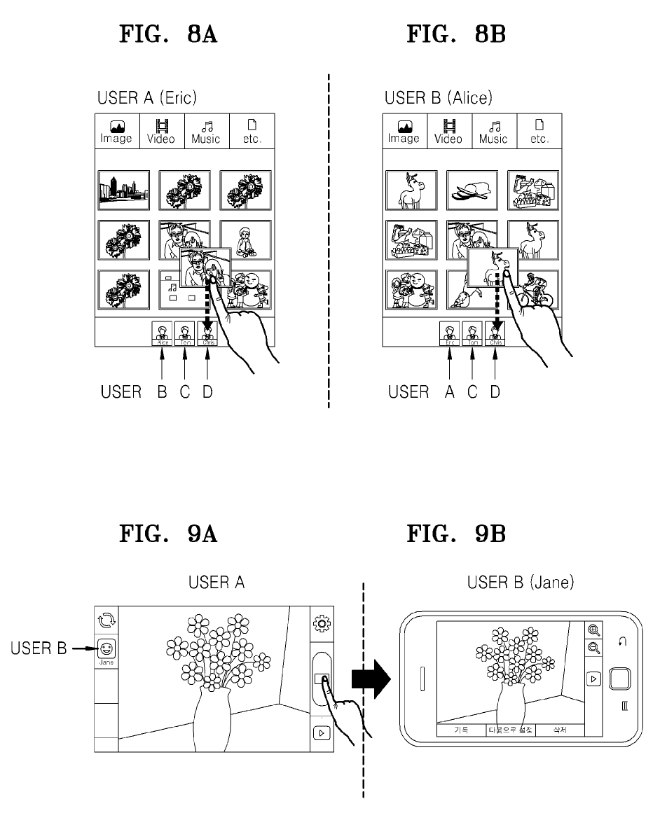

In step 503S, one of the plurality of devices recognizes a predetermined event for starting a service, a specific interaction is performed with a user of the device. For example, when device A intends to perform a service of transmitting a picture file to device D, a user of device A may drag a picture file on a touch screen to device D (or a specific user of device D), as shown in FIG. 8A. The operation of dragging the picture file is an event or user interaction that starts a picture file transfer service. Although the picture file transfer service is illustrated in this embodiment of the present invention, various other services, such as an information search service, a content streaming service, a content printing service, a file sharing service, and a remote control service, may be performed. Additionally, although the picture file dragging operation is illustrated as the event for starting a service in this embodiment of the present invention, an operations such as pushing a physical button on a device, touch and drag & paste operations on a touch screen of a device, or a voice command operation, may also be events that start a service.

In step 505S, pairing is performed between a service providing (host) device and a service receiving (guest) device. When the service providing device recognizes a predetermined event for starting a service, pairing is performed between the service providing device and the service receiving device without individually searching for a guest device to participate in the service. When the pairing is completed, information regarding the service providing device, information regarding the service receiving device, and information for performing the service are set. For example, when device A intends to perform a service of transmitting a picture file to device D, pairing between device A (the service providing device) and device D (the service receiving device) is performed, and pairing between device A and devices B and C is also performed. Specifically, pairing between any two of devices A, B, C, and D, forming the network, is simultaneously performed, thereby enabling performance of service transmission and reception between the devices. Pairing information transmitted and received between the service providing device and the service receiving device in the pairing includes information for inter-recognition and inter-connection of the two devices. Specifically, the pairing information may include IDentification (ID) information (information for recognition) and Internet Protocol (IP) address information (information for connection) of the two devices. The information for performing the service that is set when the pairing is completed may include information regarding a type of the service to be performed. For example, the service type information is set according to whether the service to be provided relates to file transfer, streaming transfer, or packet transfer. The service receiving device waits for the service according to the set service type information.

In step 507S, the pairing between the service providing device and the service receiving device ends. The pairing may end due to the setting of the information for performing the service before starting to perform the service or in the middle of performing the service. By ending the pairing in this way, pairing/service can be performed between any two devices in the network regardless of whether the service between the service providing device and the service receiving device ends. Specifically, because any two devices act as a host and a guest only once by performing pairing therebetween only once according to a service starting event, pairing/service between any two devices in the network can be performed regardless of whether the service between the service providing device and the service receiving device ends. For example, when device A intends to perform a service of transmitting a picture file to device D, pairing/service between any two of devices A, B, C, and D can be performed regardless of whether the picture file transfer service between device A and device D ends.

In step 509S, the service is performed between the service providing device and the service receiving device. However, regardless of whether the service between the service providing device and the service receiving device ends, pairing/service between any two devices in the network can be performed. Specifically, regardless of whether the service between the service providing device and the service receiving device ends, steps 503S to 509S can be performed between any two devices in the network.

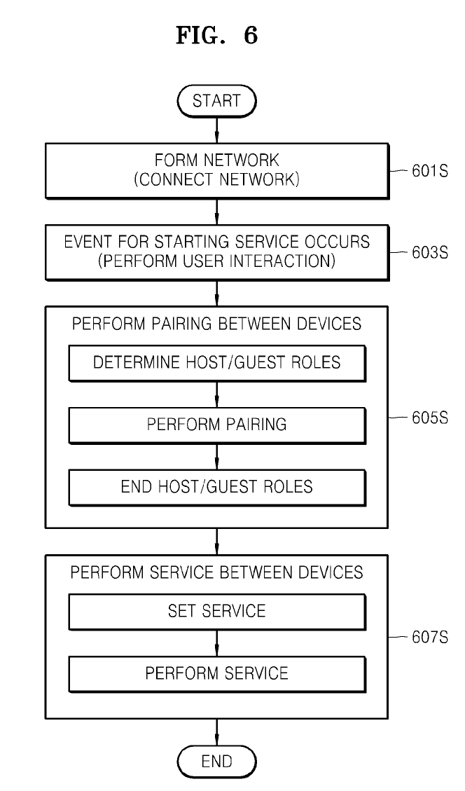

FIG. 6 is a flowchart illustrating a method of performing a service between devices in a network, according to another embodiment of the present invention. Specifically, with respect to the embodiment of the present invention illustrated in FIG. 6, pairing/service can be performed between two arbitrary devices in the network regardless of whether the service ends between the devices in the network.

Referring to FIG. 6, in step 601S, a plurality of devices form a network. For example, devices A, B, C, and D form a single network, as shown in FIG. 4.

In step 603S, one of the plurality of devices recognizes a predetermined event for starting a service, a specific interaction is performed with a user of the device. For example, when device A intends to perform a service of transmitting a picture file to device D, a user of device A may drag a picture file on a touch screen to device D (or a specific user of device D), as shown in FIG. 8A. The operation of dragging the picture file is an event or user interaction that starts a picture file transfer service. Although the picture file transfer service is illustrated in this embodiment of the present invention, various other services, such as an information search service, a content streaming service, a content printing service, a file sharing service, and a remote control service, may be performed. Additionally, although the picture file dragging operation is illustrated as the event for starting a service in this embodiment of the present invention, an operations such as pushing a physical button on a device, touch and drag & paste operations on a touch screen of a device, or a voice command operation, may also be events that start a service.

In step 605S, pairing is performed between a service providing (host) device and a service receiving (guest) device. When the service providing device recognizes a predetermined event for starting a service, pairing is performed between the service providing device and the service receiving device without individually searching for a guest device to participate in the service. For example, when device A intends to perform a service of transmitting a picture file to device D, pairing between device A (the service providing device) and device D (the service receiving device) is performed, and pairing between device A and devices B and C is also performed. Specifically, pairing between any two of devices A, B, C, and D is simultaneously performed, thereby enabling performance of service transmission and reception between the devices.

In performing the pairing, a host and a guest are first determined between the service providing device and the service receiving device, and pairing is then performed between the service providing device and the service receiving device based on the determination. When the pairing is completed, information regarding the service providing device, information regarding the service receiving device, and information for performing the service, are set.

The ending of the pairing between the service providing device and the service receiving device is achieved by ending the relationship of host and guest. The pairing may end when the information for performing the service is set before starting to perform the service or in the middle of performing the service. By ending the pairing in this way, pairing/service can be performed between any two devices in the network regardless of whether the service between the service providing device and the service receiving device ends. Specifically, because any two devices act as a host and a guest only once by performing pairing therebetween only once according to a service starting event, pairing/service between any two devices in the network can be performed regardless of whether the service between the service providing device and the service receiving device ends. For example, when device A intends to perform a service of transmitting a picture file to device D in FIG. 4, pairing/service between any two of devices A, B, C, and D can be performed regardless of whether the picture file transfer service between device A and device D ends.

Pairing information transmitted and received between the service providing device and the service receiving device in the pairing includes information for inter-recognition and inter-connection of the two devices. Specifically, the pairing information may include ID information and IP address information of the two devices. The information for performing the service that is set when the pairing is completed may include information regarding a type of the service to be performed. For example, the service type information is set according to whether the service to be provided relates to file transfer, streaming transfer, or packet transfer. The service receiving device waits for the service according to the set service type information.

In step 607S, the service is performed between the service providing device and the service receiving device. The performing of the service may be classified into one of a service setting operation and an actual service performing operation. However, regardless of whether the service between the service providing device and the service receiving device ends, pairing/service between any two devices in the network can be performed. Specifically, regardless of whether the service between the service providing device and the service receiving device ends, steps 603S to 607S are able to be performed between any two devices in the network.

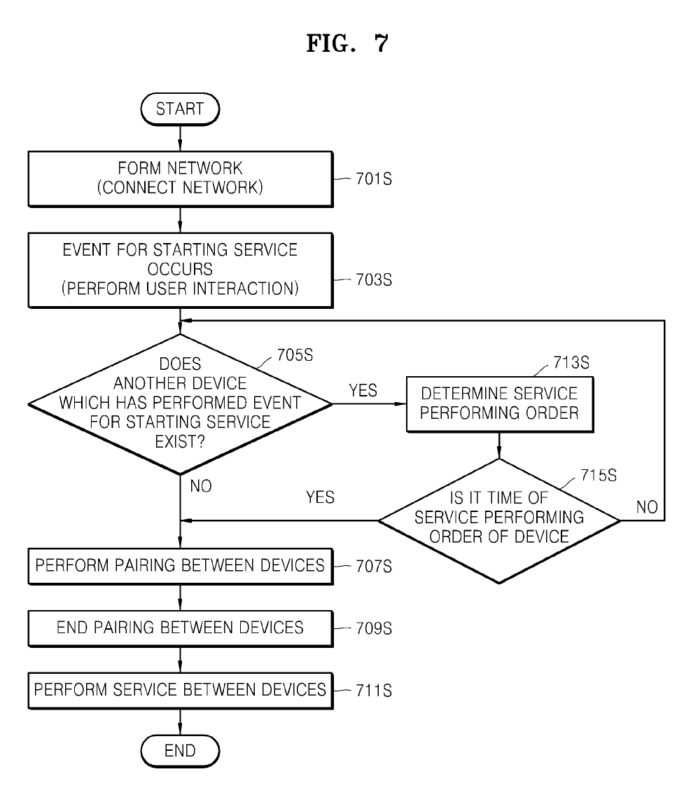

FIG. 7 is a flowchart illustrating a method of performing a service between devices in a network, according to another embodiment of the present invention. In particular, FIG. 7 illustrates a case where a service providing device and another device have the same service receiving device and an event for starting a service for the service receiving device is recognized at the same time at both the service providing device and the other device. Specifically, FIG. 7 illustrates a case where two or more service providing devices simultaneously recognize a service starting event for a single service receiving device.

Referring to FIG. 7, in step 701S, a plurality of devices form a network. For example, devices A, B, C, and D form a single network, as shown in FIG. 4.

In step 703S, one of the plurality of devices recognizes a predetermined event for starting a service, a specific interaction is performed with a user of the device. For example, when device A intends to perform a service of transmitting a picture file to device D, a user of device A may drag a picture file on a touch screen to device D (or a specific user of device D), as shown in FIG. 8A. The operation of dragging the picture file is an event or user interaction that starts a picture file transfer service. Although the picture file transfer service is illustrated in this embodiment of the present invention, various other services, such as an information search service, a content streaming service, a content printing service, a file sharing service, and a remote control service, may be performed. Additionally, although the picture file dragging operation is illustrated as the event for starting a service in this embodiment of the present invention, an operations such as pushing a physical button on a device, touch and drag & paste operations on a touch screen of a device, or a voice command operation, may also be events that start a service.

In step 705S, it is determined whether another device that has recognized the predetermined event for starting the service and has the same service receiving device as the service providing device exists among the plurality of devices participating in the network.

If no other device is found in step 705S, pairing is performed between the service providing device and the service receiving device, in step 707S. When the service providing device recognizes the predetermined event for starting the service, pairing is performed between the service providing device and the service receiving device without individually searching for a guest device to participate in the service. For example, when device A intends to perform a service of transmitting a picture file to device D, pairing between device A (the service providing device) and device D (the service receiving device) is performed, and pairing between device A and devices B and C is also performed. Specifically, pairing between any two of devices A, B, C, and D is simultaneously performed, thereby enabling performance of service transmission and reception between the devices.

When the pairing is completed, information regarding the service providing device, information regarding the service receiving device, and information for performing the service, are set. In step 709S, the pairing between the service providing device and the service receiving device ends. The pairing may end when the information for performing the service is set before starting to perform the service or in the middle of performing the service. By ending the pairing in this way, pairing/service can be performed between any two devices in the network regardless of whether the service between the service providing device and the service receiving device ends. Specifically, because any two devices act as a host and a guest only once by performing pairing therebetween only once according to a service starting event, pairing/service between any two devices in the network can be performed regardless of whether the service between the service providing device and the service receiving device ends. For example, when device A intends to perform a service of transmitting a picture file to device D in FIG. 4, pairing/service between any two of devices A, B, C, and D can be performed regardless of whether the picture file transfer service between device A and device D ends.

In step 711S, the service is performed between the service providing device and the service receiving device. However, regardless of whether the service between the service providing device and the service receiving device ends, pairing/service between any two devices in the network can be performed. Specifically, regardless of whether the service between the service providing device and the service receiving device ends, steps 703S to 715S are allowed to be performed between any two devices in the network.

If another device is found in step 705S, a service performing order between the service providing device and the found device is determined, in step 713S. Because the determined service performing order is rarely associated with service quality, the service performing order may be determined according to a predetermined criterion. For example, it may be determined that the last number streams (class D number streams) of IP addresses that are granted to devices in the network are compared with each other, and a device having a smaller number performs the service first. Specifically, when device A intends to perform a service of transmitting a picture file to device D, if device B also intends to perform the service of transmitting a picture file to device D at the same time as the device A, competition in performing the service to device D occurs between device A and device B. A pairing/service performing order is determined between device A and device B.

In step 715S, it is determined whether it is the time to provide a service with respect to the service performing order. If it is time to provide the service, the service is performed between the service providing device (device A) and the service receiving device (device D), in step 707S.

Regardless of whether the service between the service providing device and the service receiving device ends, pairing/service between any two devices in the network can be performed. Specifically, regardless of whether the service between the service providing device and the service receiving device ends, steps 703S to 715S are allowed to be performed between any two devices in the network.

If it is determined that it is not time to provide the service in step 715S, the methodology returns to step 705S to determine if another device exists. While device A is waiting for its time in the service performing order, pairing/service of device B is performed. The service provided by device A may be identical to or different from the service provided by device B. For example, when the service provided from device A to device D is the picture file transfer service, the service provided from device B to device D may be the picture file transfer service or another service, such as the content streaming service.

FIGS. 8A and 8B illustrate display screens of two devices of a plurality of devices participating in a network, according to an embodiment of the present invention. When devices A, B, C, and D participate in a network, as shown in FIG. 4, display screens of devices A and D are illustrated in FIGS. 8A and 8B. For example, when device A intends to perform a service of transmitting a picture file to device D, the user of device A may drag a picture file on a touch screen to device D (or a user of device D, Chris), as shown in FIG. 8A. The operation of dragging the picture file is an event that starts the picture file transfer service. Although the picture file transfer service is illustrated in the current embodiment, various services, such as an information search service, a content streaming service, a content printing service, a file sharing service, and a remote control service, may be performed. Additionally, although the picture file dragging operation is illustrated as the event for starting a service in this embodiment of the present invention, operations such as pushing a physical button on a device, touch and drag & paste operations on a touch screen of a device, or a voice command operation, may also be events for starting a service.

As shown in FIG. 8B, a user of device B may transmit a picture file to device D by dragging a picture file on a touch screen to device D. When both device A and device B perform the service of transmitting a picture file to device D, the services provided by the plurality of service providing devices are independently performed. Specifically, devices A and B participating in the network independently perform pairing/service for device D. In FIG. 4, the performing of pairing is indicated by dashed arrows, and the performing of a service is indicated by solid arrows. Because pairing/service is independently performed between devices participating in the network, while device A is performing the service with device B, device A may be able to simultaneously perform pairing/service with devices C and D. However, when pairing between devices A and D and pairing between devices B and D are performed at the same time, a pairing performing order is determined.

FIGS. 9A and 9B are diagrams for describing an operation of providing a mutual immediate service between a plurality of devices participating in a network, according to an embodiment of the present invention. If a user of device A presses a capturing button of a device thereof, an image captured by the user of device A is immediately displayed/shared on a display screen of device B.

An icon of the user of device B displayed on the left side of a display screen, as shown in FIG. 9A, indicates that the user of device A has recognized the user of device B as a user participating in a network. In this state, if an event for starting a service is recognized (e.g., the capturing button is pressed), pairing is performed between the devices A and B, and after the pairing is completed, information regarding a service providing device, information regarding a service receiving device, and information for performing the service, are set. Then, the pairing ends. Thereafter, a corresponding service is performed in device B. At this time, a separate authentication or selection for performing the service is not required for device B. The authentication for performing the service requires an acceptance for receiving content in the guest mode, and a physical input device for performing an authentication operation. Thus, devices cannot freely share content as soon as they form a network. However, because device B does not require setting a network group, checking a host/guest mode in performing a service, waiting for an additional service in performing a service, or authentication for performing a service, users of devices A and B simply share content.

Referring to FIGS. 9A and 9B, when the user of device A presses the capturing button of device A, an image captured by device A is immediately displayed on the display screen of device B. Because the pairing between the devices A and B has ended, pairing/service between any two devices in the network can be performed regardless of whether the service between the service providing device and the service receiving device ends. For example, even though device A performs a service of transmitting a picture file to device B in the network of FIG. 4, pairing/service between any two of devices A, B, C, and D can be performed regardless of whether the picture file transfer service between device A and device B ends.

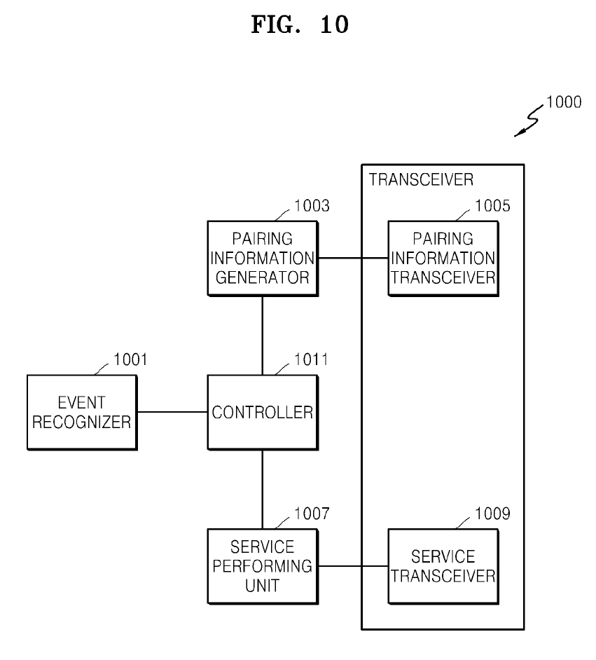

FIG. 10 is a block diagram of a device for performing a service in a network, according to an embodiment of the present invention. Referring to FIG. 10, a device 1000 includes an event recognizer 1001, a pairing information generator 1003, a pairing information transceiver 1005, a service performing unit 1007, a service transceiver 1009, and a controller 1011. The device 1000 performs a service by participating in a network formed with a plurality of devices.

The event recognizer 1001 recognizes a predetermined event for starting a service. For example, when device A intends to perform a service of transmitting a picture file to device D in FIG. 4, a user A of device A may drag a picture file on a touch screen to device D, as shown in FIG. 8A.

The pairing information generator 1003 generates information regarding pairing performed between the device 1000 and the other device of the service. The pairing information transceiver 1005 transmits and receives the generated pairing information between the device 1000 and the other device of the service. Through pairing information transmission and reception, pairing is performed between the device 1000 providing the service and the other device of the service. For example, when device A intends to perform a service of transmitting a picture file to device D in FIG. 4, pairing between device A and device D is performed. As described above, the pairing is performed by transmitting and receiving the pairing information generated by the pairing information generator 1003. By ending the pairing between the service providing device and the other device of the service, pairing/service can be performed between any two devices in the network regardless of whether the service between the service providing device and the other device of the service ends. For example, when device A intends to perform a service of transmitting a picture file to device D, pairing/service between any two of devices A, B, C, and D can be performed regardless of whether the picture file transfer service between device A and device D ends.

The service performing unit 1007 performs a service. The service transceiver 1009 transmits and receives the performed service between the device 1000 and the other device of the service. The service is performed between the service providing device 1000 and the other device of the service. Regardless of whether the service between such a service providing device and such a service receiving device ends, pairing/service between any two devices in the network can be performed.

The controller 1011 controls the event recognizer 1001, the pairing information generator 1003, the pairing information transceiver 1005, the service performing unit 1007, and the service transceiver 1009. The controller 1011 may be configured with a memory for storing a program for controlling the event recognizer 1001, the pairing information generator 1003, the pairing information transceiver 1005, the service performing unit 1007, and the service transceiver 1009, and a processor for performing the program.

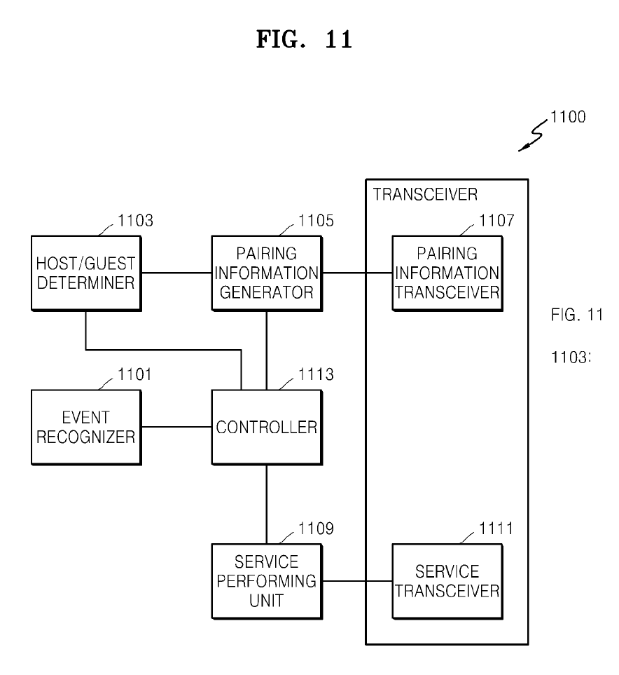

FIG. 11 is a block diagram of a device for performing a service in a network, according to another embodiment of the present invention. Referring to FIG. 11, a device 1100 includes an event recognizer 1101, a host/guest determiner 1103, a pairing information generator 1105, a pairing information transceiver 1107, a service performing unit 1109, a service transceiver 1111, and a controller 1113. The device 1100 performs a service by participating in a network formed with a plurality of devices. According to an embodiment of the present invention illustrated in FIG. 11, regardless of whether a service between devices participating in the network ends, pairing/service between any two devices in the network can be performed.

The event recognizer 1101 recognizes a predetermined event for starting a service. For example, when device A intends to perform a service of transmitting a picture file to device D in FIG. 4, a user of device A may drag a picture file on a touch screen to device D, as shown in FIG. 8A.

The host/guest determiner 1103 determines a host and a guest between the device 1100 and the other device of the service. The pairing information generator 1105 generates information regarding pairing performed between the device 1100 and the other device of the service based on the determination of the host/guest determiner 1103. The pairing information transceiver 1107 transmits and receives the generated pairing information between the device 1100 and the other device of the service. Pairing is performed between the device 1100 and the other device of the service by the host/guest determiner 1103, the pairing information generator 1105, and the pairing information transceiver 1107. For example, when device A intends to perform a service of transmitting a picture file to device D in FIG. 4, pairing between device A and device D is performed (dashed arrow). A host and a guest are first determined between the service providing device and the other device of the service, and pairing is then performed between the service providing device and the other device of the service based on the determination. When the pairing is completed, information regarding the service providing device, information regarding the other device of the service, and information for performing the service, are set. Then, the pairing ends. The ending of the pairing is achieved by ending the relationship as host and guest. By ending the pairing in this way, pairing/service can be performed between any two devices in the network regardless of whether the service between the service providing device and the other device of the service ends. For example, when device A intends to perform a service of transmitting a picture file to device D in FIG. 4, pairing/service between any two of devices A, B, C, and D can be performed regardless of whether the picture file transfer service between device A and device D ends.

The service performing unit 1109 performs a service. The service transceiver 1111 transmits and receives the performed service between the device 1100 and the other device of the service. The service is performed between the service providing device 1100 and the other device of the service. The performing of the service may be classified into a service setting operation and an actual service performing operation. Regardless of whether the service between the service providing device 1100 and the other device of the service ends, pairing/service between any two devices in the network can be performed.

The controller 1113 controls the event recognizer 1101, the host/guest determiner 1103, the pairing information generator 1105, the pairing information transceiver 1107, the service performing unit 1109, and the service transceiver 1111. The controller 1113 may be configured with a memory for storing a program for controlling the event recognizer 1101, the host/guest determiner 1103, the pairing information generator 1105, the pairing information transceiver 1107, the service performing unit 1109, and the service transceiver 1111, and a processor for performing the program.

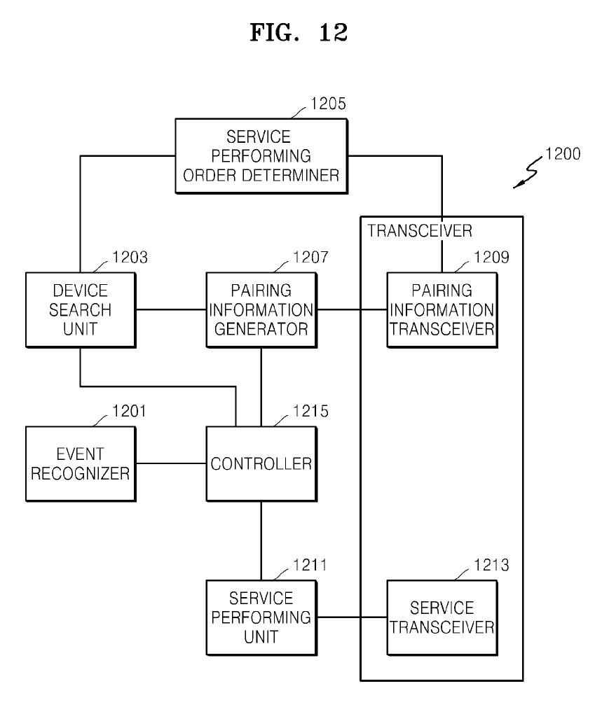

FIG. 12 is a block diagram illustrating a device for performing a service in a network, according to another embodiment of the present invention. Referring to FIG. 12, a device 1200 includes an event recognizer 1201, a device search unit 1203, a service performing order determiner 1205, a pairing information generator 1207, a pairing information transceiver 1209, a service performing unit 1211, a service transceiver 1213, and a controller 1215. The device 1200 performs a service by participating in a network formed with a plurality of devices. According to the embodiment of the present invention illustrated in FIG. 12, regardless of whether a service between devices participating in the network ends, pairing/service between any two devices in the network can be performed.

The event recognizer 1201 recognizes a predetermined event for starting a service.

The device search unit 1203 searches for the presence of another device that recognizes a predetermined event and has the same device that is the other party of the service as the device 1200.

If another device is found as a search result of the device search unit 1203, the service performing order determiner 1205 determines a service performing order between the device 1200 and the found device. For example, when device A intends to perform a service of transmitting a picture file to device D, if device B also intends to perform the service of transmitting a picture file to device D at the same time as the device A, a pairing/service performing order is determined between device A and device B. If it is time for device A to provide the service in accordance with the service performing order, the service between the device 1200 (device A) and the other device of the service (device D) is performed. However, regardless of whether the service between the service providing device and the other device of the service ends, pairing/service between any two devices in the network can be performed. Otherwise, if it is time for the other device to provide the service in accordance with the service performing order, another device that recognizes the predetermined event for starting the service and has the same service receiving device as the service providing device is again searched for. While device A is waiting for its own service performing order, pairing/service of device B is performed.

The pairing information generator 1207 generates information regarding pairing performed between the device 1200 and the other device of the service. The pairing information transceiver 1209 transmits and receives the pairing information between the device 1200 and the other device of the service if it is time to provide the service based on the service performing order determined by the service performing order determiner 1205. Pairing is performed between the device 1200 providing the service and the other device of the service by the pairing information generator 1207 and the pairing information transceiver 1209.

The service performing unit 1211 performs a service. The service transceiver 1213 transmits and receives the performed service between the device 1200 and the other device of the service.

The controller 1215 controls the event recognizer 1201, the device search unit 1203, the service performing order determiner 1205, the pairing information generator 1207, the pairing information transceiver 1209, the service performing unit 1211, and the service transceiver 1213. The controller 1215 may be configured with a memory for storing a program for controlling the event recognizer 1201, the device search unit 1203, the service performing order determiner 1205, the pairing information generator 1207, the pairing information transceiver 1209, the service performing unit 1211, and the service transceiver 1213, and a processor for performing the program.

Software components including instructions or code for performing the methodologies described herein may be stored in one or more of the associated memory devices (e.g., Read Only Memory (ROM), fixed or removable memory) and, when ready to be utilized, loaded in part or in whole (e.g., into Random Access Memory (RAM)) and executed by a Central Processing Unit (CPU).

While the invention has been shown and described with reference to certain embodiments thereof, it will be understood by those skilled in the art that various changes in form and detail may be made therein without departing from the spirit and scope of the invention as defined by the appended claims. The embodiments should be considered in a descriptive sense only and not for purposes of limitation.

What is claimed is:

1. A method of performing a service between devices in a network, the method comprising the steps of:
recognizing, in a first device, a predetermined event for starting the service;
performing a pairing between the first device and a second device that is a party of the service;
ending the pairing by setting information for performing the service; and
performing the service between the first device and the second device,
wherein the pairing is ended before or during performance of the service.

2. The method of claim 1, wherein the service comprises at least one of an information search service, a file transfer service, a content streaming service, a content printing service, a file sharing service, and a remote control service.

3. The method of claim 1, wherein the predetermined event comprises at least one of an operation of pushing a physical button on the first device, at least one of a touch operation, a drag operation, and a drag & paste operation on a touch screen of the first device, and a voice command operation.

4. A method of performing a service between devices in a network, the method comprising the steps of:
recognizing, in a first device, a predetermined event for starting the service;
determining a host device and a guest device from the first device and a second device that is a party of the service;
performing a pairing between the first device and the second device based on the determination of the host device and the guest device;
ending the pairing by setting information for performing the service; and
performing the service between the first device and the second device,
wherein the pairing is ended before or during performance of the service.

5. The method of claim 4, wherein the service comprises at least one of an information search service, a file transfer service, a content streaming service, a content printing service, a file sharing service, and a remote control service.

6. The method of claim 4, wherein the predetermined event comprises at least one of an operation of pushing a physical button on the first device, at least one of a touch operation, a drag operation, and a drag & paste operation on a touch screen of the first device, and a voice command operation.

7. A method of performing a service between devices in a network, the method comprising the steps of:
forming the network with a plurality of devices;
recognizing, in a first device of the plurality of devices, a predetermined event for starting the service with a second device of the plurality of devices;
searching for another device, from among the plurality of devices, that has recognized the predetermined event and has the second device as another party of the service;
when another device is not found, performing pairing between the first device and the second device;
when another device is found, determining a service performing order between the first device and the found device, and performing the pairing between the first device and the second device when it is time to provide the service by the first device in accordance with the service performing order;
ending the pairing by setting information for performing the service; and
performing the service between the first device and the second device,
wherein the pairing is ended before or during performance of the service.

8. The method of claim 7, wherein the service comprises at least one of an information search service, a file transfer service, a content streaming service, a content printing service, a file sharing service, and a remote control service.

9. The method of claim 7, wherein the predetermined event comprises at least one of an operation of pushing a physical button on the first device, at least one of a touch operation, a drag operation, and a drag & paste operation on a touch screen of the first device, and a voice command operation.

10. A device for performing a service in a network, the device comprising:
an event recognizer for recognizing a predetermined event for starting the service;
a pairing information generator for generating information regarding pairing performed between the device and another device of the service;
a pairing information transceiver for transmitting and receiving the pairing information between the device and the other device of the service;
a service performing unit for performing the service;
a service transceiver for transmitting and receiving the performed service between the device and the other device of the service; and
a controller for controlling the event recognizer, the pairing information generator, the pairing information transceiver, the service performing unit, and the service transceiver,
wherein the transmission and reception of the pairing information end before or during performance of the service.

11. The device of claim 10, wherein the service comprises at least one of an information search service, a file transfer service, a content streaming service, a content printing service, a file sharing service, and a remote control service.

12. The device of claim 10, wherein the predetermined event comprises at least one of an operation of pushing a physical button on the device, at least one of a touch operation, a drag operation, and a drag & paste operation on a touch screen of the device, and a voice command operation.

13. A device for performing a service in a network, the device comprising:
an event recognizer for recognizing a predetermined event for starting the service;
a host/guest determiner for determining a host device and a guest device from the device and an other device of the service;
a pairing information generator for generating information regarding pairing performed between the device and the other device of the service based on the determination of the host device and the guest device;
a pairing information transceiver for transmitting and receiving the pairing information between the device and the other device of the service;
a service performing unit for performing the service;
a service transceiver for transmitting and receiving the performed service between the device and the other device of the service; and
a controller for controlling the event recognizer, the host/guest determiner, the pairing information generator, the pairing information transceiver, the service performing unit, and the service transceiver,
wherein the transmission and reception of the pairing information end before or during performance of the service.

14. The device of claim 13, wherein the service comprises at least one of an information search service, a file transfer service, a content streaming service, a content printing service, a file sharing service, and a remote control service.

15. The device of claim 13, wherein the predetermined event comprises at least one of an operation of pushing a physical button on the device, at least one of a touch operation, a drag operation, and a drag & paste operation on a touch screen of the device, or a voice command operation.

16. A device for performing a service in a network, the device comprising:
an event recognizer for recognizing a predetermined event for starting the service with a second device;
a device search unit for searching for another device that has recognized the predetermined event and has the second device as another party of the service;
a service performing order determiner for, when another device is found, determining a service performing order between the device and the found device;
a pairing information generator for generating information regarding pairing performed between the device and the second device;
a pairing information transceiver for transmitting and receiving the pairing information between the device and the second device, when it is time to provide the service by the first device in accordance with the determined service performing order;
a service performing unit for performing the service;
a service transceiver for transmitting and receiving the performed service between the device and the second device; and
a controller for controlling the event recognizer, the device search unit, the service performing order determiner, the pairing information generator, the pairing information transceiver, the service performing unit, and the service transceiver,
wherein the transmission and reception of the pairing information end before or during performance of the service.

17. The device of claim 16, wherein the service comprises at least one of an information search service, a file transfer service, a content streaming service, a content printing service, a file sharing service, and a remote control service.

18. The device of claim 16, wherein the predetermined event comprises at least one of an operation of pushing a physical button on the device, at least one of a touch operation, a drag operation, and a drag & paste operation on a touch screen of the device, and a voice command operation.

19. A non-transitory computer-readable recording medium storing a computer-readable program for performing a service between devices in a network, the computer-readable program which when executed implements the steps of:
recognizing, in a first device, a predetermined event for starting the service;
performing a pairing between the first device and a second device that is a party of the service;
ending the pairing by setting information for performing the service; and
performing the service between the first device and the second device,
wherein the pairing is ended before or during performance of the service.
